(19) United States
(12) Patent Application Publication
(10) Pub. No.: US 2011/0148598 A1
(43) Pub. Date: Jun. 23, 2011

(54) RFID SYSTEM

(75) Inventor: Hee Bok KANG, Cheongju (KR)

(73) Assignee: Hynix Semiconductor Inc., Icheon (KR)

(21) Appl. No.: 12/792,513

(22) Filed: Jun. 2, 2010

(30) Foreign Application Priority Data
Dec. 23, 2009 (KR) 10-2009-0129398

(51) Int. Cl. G08B 5/22; H04Q 5/22

(52) U.S. Cl. 340/10.6; 340/10.5

(57) ABSTRACT

An RFID system includes: an input unit configured to generate a command signal according to a radio signal applied through an antenna; a digital unit configured to control the command signal and generate an address, data, and a control signal; a memory unit configured to perform a data read or write operation according to the control signal applied from the digital unit; a coupling unit coupled to an external driving device; and a driving controller configured to output a driving signal, which controls the driving device according to data stored in the memory unit, to the coupling unit, wherein the memory unit includes a first address area which stores data for transmitting and receiving the radio signal, and a second address area which stores data for controlling the driving device.

### CROSS-REFERENCE TO RELATED APPLICATION

The priority based on Korean patent application No. 10-2009-129398, filed on Dec. 23, 2009, the disclosure of which is hereby incorporated in its entirety by reference, is claimed.

### BACKGROUND OF THE INVENTION

Embodiment in accordance with the present invention relates to a radio frequency identification (RFID) system, and more specifically, to an RFID tag technology which is capable of automatically identifying an object by communicating with an external reader through transmission/reception of a radio signal.

An RFID is a contactless identification technology which can identify an object by using a radio signal. Specifically, an RFID tag is attached to an object to be identified, and the RFID tag communicates with an RFID reader through transmission/reception of a radio signal. In this manner, the identification of the object is achieved. The use of the RFID can overcome the shortcomings of a conventional automatic identification technology, such as a barcode and an optical character recognition technology.

In recent years, RFID tags have been used in various fields, such as a distribution management system, a user authentication system, an electronic cash system, a traffic system, and so on.

For example, a distribution management system performs a commodity classification or an inventory management by using integrated circuit (IC) tags (in which data are recorded) instead of a delivery statement or tag. In another example, a user authentication system performs a room management by using IC cards in which personal information is recorded.

Meanwhile, a memory used in the RFID tag may be implemented with a nonvolatile ferroelectric memory.

In general, a nonvolatile ferroelectric memory (i.e., a ferroelectric random access memory (FeRAM)) is considered by many as a next generation storage device because it has a data processing speed similar to that of a dynamic random access memory (DRAM) and data is retained even when power is interrupted.

The FeRAM has a structure substantially similar to that of the DRAM but uses a ferroelectric capacitor as a storage element. Ferroelectric material has a high remnant polarization characteristic. As a result, data is not erased even though an electric field is removed.

FIG. 1 illustrates an overall structure of a general RFID device.

The RFID device includes an antenna unit 1, an analog unit 10, a digital unit 20, and a memory unit 30.

The antenna unit 1 receives a radio signal transmitted from an external RFID reader. The radio signal received through the antenna unit 1 is inputted to the analog unit 10 through antenna pads 11 and 12.

The analog unit 10 amplifies the inputted radio signal and generates a power supply voltage VDD which can then be used as a driving voltage of the RFID tag. The analog unit 10 detects an operation command signal CMD from the inputted radio signal, and outputs the command signal CMD to the digital unit 20. In addition, the analog unit 10 detects the output voltage VDD and outputs a power on reset signal POR and a clock CLK to the digital unit 20. The power on reset signal POR is a signal which controls a reset operation.

The digital unit 20 receives the power supply voltage VDD, the power on reset signal POR, the clock CLK, and the command signal CMD from the analog unit 10, and outputs a response signal RP to the analog unit 10. In addition, the digital unit 20 outputs an address ADD, an input/output data I/O, a control signal CTR, and the clock CLK to the memory unit 30.

The memory unit 30 reads, writes and stores data by using a memory device.

The RFID device uses several frequency bands, and the device characteristics vary depending on the frequency bands. In general, as the frequency band is lowered, the recognition speed of the RFID device becomes slower, the RFID device operates with a shorter distance and is less influenced by the environment. On the other hand, as the frequency band becomes higher, the recognition speed of the RFID device becomes faster, the RFID device operates at a longer distance and is greatly influenced by the environment.

### BRIEF SUMMARY OF THE INVENTION

Various embodiments of the present invention are directed to providing an RFID system which can remotely control display devices such as light emitting diodes (LEDs) through an RFID chip by coupling the display devices to the RFID chip.

Various embodiments of the present invention are directed to providing an RFID system which can control LEDs in various manners by providing nonvolatile registers for storing LED operation command data within an RFID chip.

Various embodiments of the present invention are directed to providing an RFID system which can control LEDs according to a radio signal or a wired signal by using an RFID chip.

In an embodiment of the present invention, a radio frequency identification (RFID) system includes: an input unit configured to generate a command signal according to a radio signal applied through an antenna; a digital unit configured to generate an address, input/output data, and a control signal based on the command signal; a memory unit configured to perform a data read or write operation according to the control signal and the address applied from the digital unit, the memory unit including a first address area to store first data for transmitting and receiving the radio signal, and a second address area to store second data for controlling an external driving device; a coupling unit configured to couple the external driving device and the RFID system; and a driving controller configured to output a driving signal, for controlling the driving device according to second data stored in the memory unit, and output the driving signal to the coupling unit.

### BRIEF DESCRIPTION OF THE DRAWINGS

FIG. 1 is a block diagram of a general RFID device.

FIG. 2 is a block diagram of an RFID system according to an embodiment of the present invention.

FIGS. 3 and 4 are flowcharts showing an operation of the RFID system according to an embodiment of the present invention.

FIG. 5 is a diagram showing a data type stored in a register of FIG. 2.

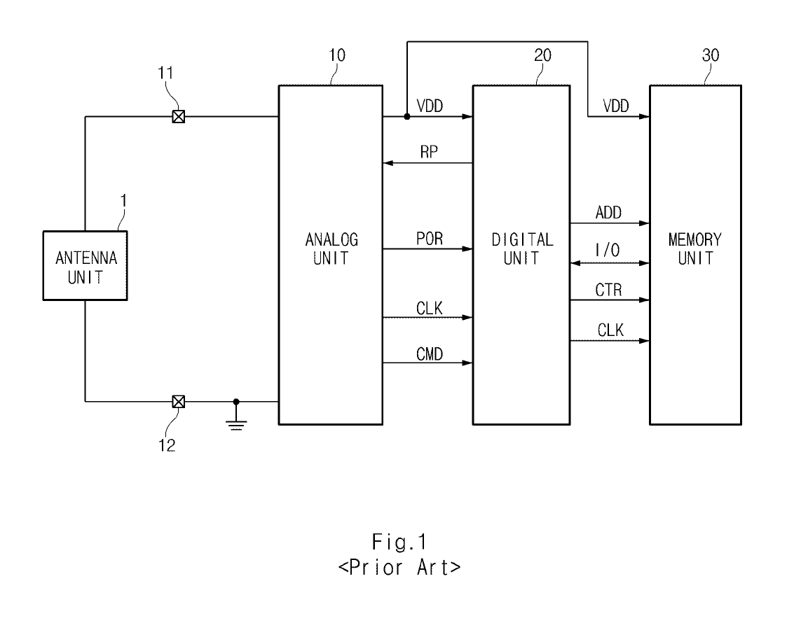

### DESCRIPTION OF EMBODIMENTS

Description of the embodiments of the present invention will now be made in detail with reference to the accompanying drawings. Wherever possible, the same reference numbers will be used throughout the drawings to refer to the same or like elements.

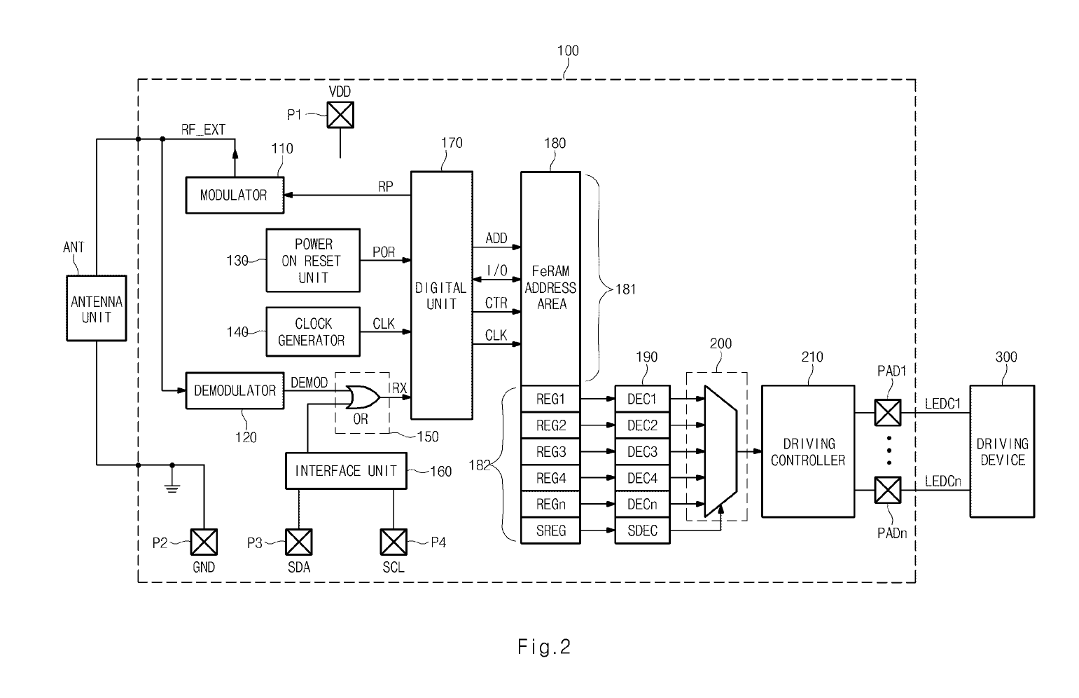

FIG. 2 is a block diagram of an RFID chip 100 in an RFID system according to an embodiment of the present invention.

The RFID chip 100 is coupled to an antenna unit ANT. The RFID chip 100 includes a modulator 110, a demodulator 120, a power on reset unit 130, a clock generator 140, a command signal input unit 150, an interface unit 160, a digital unit 170, a memory unit 180, a decoding unit 190, a selector 200, a driving controller 210, a plurality of output pads PAD1 to PADn, a power supply voltage (VDD) pad P1, a ground voltage (GND) pad P2, a data input pad P3, and a clock input pad P4, wherein n is a positive integer.

The plurality of output pads PAD1 to PADn are coupled to an driving device 300. The demodulator 120 to which a radio signal RF_EXT is inputted through the antenna unit ANT, the command signal input unit 150, the interface unit 160, the data input pad P3, and the dock input pad P4 correspond to an “input block”.

As illustrated in FIG. 2, the concept of the “RFID system” defined in the title of the invention includes the RFID chip 100 and the driving device 300.

First, the antenna unit ANT receives an external radio signal RF_EXT transmitted from an external RFID reader. The external radio signal RF_EXT received in the RFID chip 100 through the antenna unit ANT is inputted to the demodulator 120 through an antenna pad (not shown).

The antenna unit ANT also transmits an internal radio signal received from the RFID chip 100 to the external RFID reader. The internal radio signal applied from the modulator 110 to the antenna unit ANT is transmitted to the external RFID reader through the antenna pad (not shown).

The demodulator 120 generates a command signal DEMOD by demodulating the external radio signal RF_EXT applied from the antenna unit ANT, and outputs the command signal DEMOD to the command signal input unit 150. The modulator 110 generates the internal radio signal by modulating a response signal RP applied from the digital unit 170, and outputs the internal radio signal to the antenna unit ANT.

Furthermore, the power on reset unit 130 detects the power supply voltage VDD generated at the power supply voltage pad P1, and outputs a power on reset signal POR to the digital unit 170. The power on reset signal POR is a signal which controls a reset operation.

The power on reset signal POR rises with the power supply voltage while the power supply voltage is changing from a low level to a high level. The power on reset signal POR then changes from a high level to a low level at the moment that the power supply voltage reaches the power supply voltage level VDD, thereby resetting an internal circuit of the RFID chip 100.

The clock generator 140 supplies the digital unit 170 with a clock CLK which controls an operation of the digital unit 170, depending on the power supply voltage VDD generated at the power supply voltage pad P1.

In this embodiment, the RFID chip 100 is driven by the external power supply voltage pad P1 and the external ground voltage pad P2. In a conventional RFID tag, when the RFID tag receives the radio signal through communication with the RFID reader, the power supply voltage is supplied through a voltage amplification unit provided inside the RFID tag.

In this embodiment, however, a large amount of power is consumed because the RFID chip 100 is coupled to the driving device 300. Accordingly, in this embodiment, the power supply voltage VDD and the ground voltage GND are supplied to the RFID chip 100 through the additional external power supply voltage pad P1 and the additional external ground voltage pad P2.

In addition, the command signal input unit 150 outputs the command signal DEMOD applied from the demodulator 120 as a command signal RX, or outputs a signal applied from the interface unit 160 as the command signal RX. The command signal input unit 150 includes an OR gate OR and outputs the command signal RX to the digital unit 170 when either the output of the demodulator 120 or the output of the interface unit 160 is activated.

That is, the driving device 300 may be controlled according to the radio signal RF_EXT applied through the demodulator 120, or the driving device 300 may be controlled according to a serial protocol applied through the interface unit 160, which is, a wired signal.

The interface unit 160 is configured to input and output an inter-integrated circuit (I2C) signal. The interface unit 160 is coupled to the data input pad P3 to which a serial data SDA is applied, and the clock input pad P4 to which a serial clock SCL is applied. The interface unit 160 controls an I2C interface operation according to the serial data SDA applied through the data input pad P3 and the serial clock SCL applied through the clock input pad P4. The interface unit 160 also outputs the I2C signal to the command signal input unit 150. The interface unit 160 may include an I2C port.

The clock SCL applied through the clock input pad P4 refers to a serial clock used in the I2C port, and the data SDA applied through the data input pad P3 refers to a serial data used in the I2C port.

In addition, the digital unit 170 receives the power supply voltage VDD, the power on reset signal POR, the dock CLK, and the command signal RX. The digital unit 170 interprets the command signal RX and generates a control signal and processing signals. The digital unit 170 outputs the response signal RP corresponding to the control signal and the processing signals to the modulator 110. Also, the digital unit 170 outputs an address ADD, input/output data I/O, the control signal CTR, and the clock CLK to the memory unit 180.

Furthermore, the memory unit 180 includes a FeRAM (nonvolatile ferroelectric memory) address area 181 which stores data for transmitting and receiving the radio signal RF_EXT, and a register address area 182 which stores an LED control command data for controlling the driving device 300.

In the memory unit 180, the FeRAM address area 181 includes a plurality of memory cells, each of which writes data to a storage element and reads data stored in the storage element.

The FeRAM has a data processing speed similar to that of DRAM. Also, the FeRAM has a structure substantially similar to that of DRAM. Since ferroelectric material is used as a capacitor, the FeRAM has a high remnant polarization which is a characteristic of ferroelectric material. Due to such a remnant polarization characteristic, data is not erased even though an electric field is removed.

The register address area 182 includes a plurality of registers REG1 to REGn and a selection register SREG. That is, in addition to the FeRAM address area 181 for storing a unique ID of the RFID chip 100, the register address area 182 is further provided to store LED driving commands.

The plurality of registers REG1 to REGn store several operation commands for driving a display device, such as an LED, in an n-bit data area. The selection register SREG stores information for selecting a desired command among several operation commands for driving the display device such as an LED.

In addition, the decoding unit 190 includes a plurality of decoders DEC1 to DECn and a selection decoder SDEC. The plurality of decoders DEC1 to DECn are coupled to the plurality of registers REG1 to REGn in 1:1 correspondence, and decode signals outputted from the plurality of registers REG1 to REGn. The selection decoder SDEC is coupled to the selection register SREG, and decodes a signal outputted from the selection register SREG.

The selector 200 may include a multiplexer. The selector 200 selects one of the outputs of the decoders DEC1 to DECn in response to the output of the selection decoder SDEC.

The driving controller 210 is coupled between the selector 200 and the plurality of output pads PAD1 to PADn. The driving controller 210 outputs control signals LEDC1 to LEDCn to the plurality of output pads PAD1 to PADn according to a driving control signal applied from the selector 200. The control signals LEDC1 to LEDCn are for controlling the operation of the driving device 300, which is provided outside the RFID chip 100. The driving device 300 is coupled to the driving controller 210 of the RFID chip 100 through the plurality of output pads PAD1 to PADn.

The plurality of output pads PAD1 to PADn are coupled to the driving device 300 through connection pins, and correspond to a coupling unit which couples the RFID chip 100 to the driving device 300. The control signals LEDC1 to LEDCn outputted from the plurality of output pads PAD1 to PADn are inputted to the driving device 300.

The driving device 300 controls an operation of a display device such as an LED, a motor, or a speaker. A case in which the driving device 300 controls a display device such as the LED will be described below as an embodiment of the present invention.

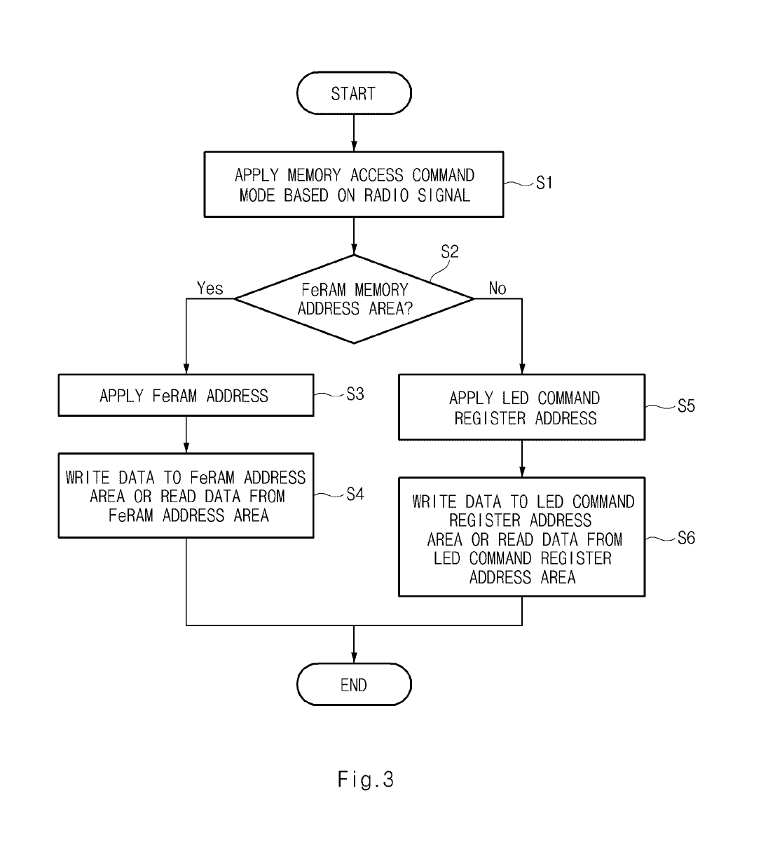

FIG. 3 is a flowchart showing an operation of controlling the driving device 300 according to the radio signal RF_EXT inputted through the antenna unit ANT.

First, the radio signal RF_EXT applied through the antenna unit ANT is inputted to the demodulator 120. The demodulator 120 decodes the radio signal RF_EXT and outputs the command signal DEMOD to the command signal input unit 150. When the command signal DEMOD is inputted to the command signal input unit 150, the command signal input unit 150 activates the command signal RX and outputs the activated command signal RX.

Subsequently, the digital unit 170 generates and outputs the address ADD, the input/output data I/O, the control signal CTR, and the clock CLK to the memory unit 180 based on the command signal RX.

When a memory access command mode is applied by the radio signal RF_EXT (step S1), the digital unit 170 interprets the command signal RX and determines whether the memory access command mode corresponds to the FeRAM address area (step S2).

When the command signal RX applied to the digital unit 170 corresponds to an FeRAM access mode, an FeRAM address is applied to the memory unit 180 (step S3).

In this case, the FeRAM address area 181 of the memory unit 180 is activated. Accordingly, a data write or read operation is performed on the FeRAM address area 181 (step S4).

On the other hand, when the command signal RX applied to the digital unit 170 does not correspond to the FeRAM access mode but an LED command register access mode, an LED command register address is applied to the memory unit 180 (step S5).

In this case, the register address area 182 of the memory unit 180 is activated. Accordingly, the data write or read operation is performed on the LED command register address area, i.e., the register address area 182 (step S6).

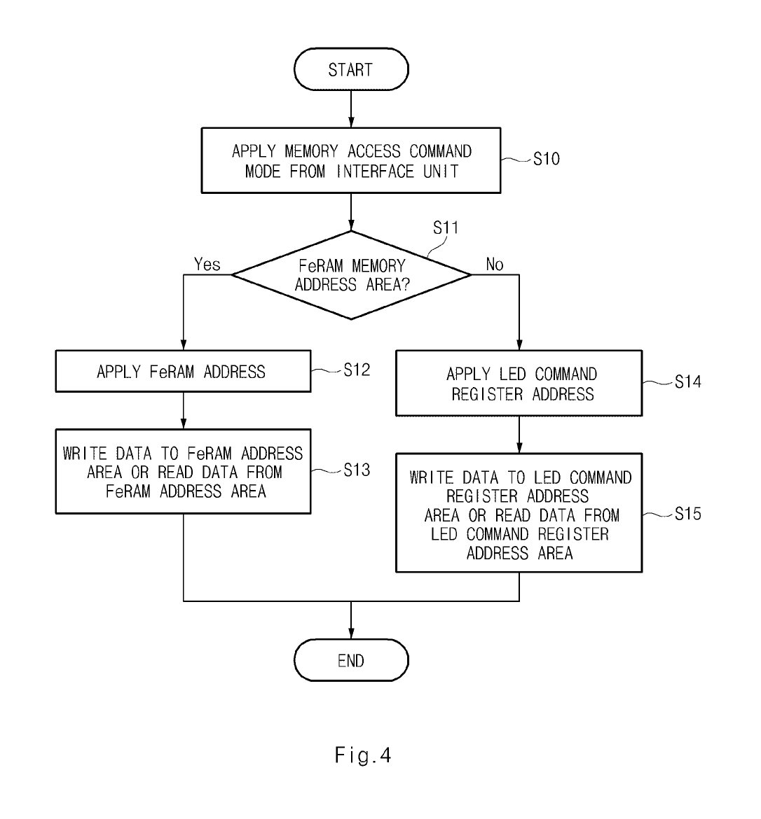

FIG. 4 is a flowchart showing an operation of controlling the driving device 300 according to the serial data SDA inputted through the interface unit 160.

First, the serial data SDA and the serial clock SCL are applied through the data input pad P3 and the clock input pad P4 to the interface unit 160. That is, the interface unit 160 defines a data type based on a serial interface signal corresponding to the serial data SDA and the serial dock SCL and generates the command signal. The command signal generated based on the serial data SDA and the serial dock SCL applied through the I2C port of the interface unit 160 is outputted to the command signal input unit 150.

The command signal input unit 150 outputs the activated command signal RX when the serial data SDA and the serial clock SCL are applied through the interface unit 160.

Subsequently, the digital unit 170 generates and outputs the address ADD, the input/output data I/O, the control signal CTR, and the clock CLK to the memory unit 180 based on the command signal RX.

When the memory access command mode is applied to the digital unit 170 by the interface unit 160 (step S10), the digital unit 170 interprets the command signal RX and determines whether the memory access mode corresponds to the FeRAM address area (step S11).

When the command signal RX applied to the digital unit 170 corresponds to the FeRAM access mode, the FeRAM address is applied to the memory unit 180 (step S12).

In this case, the FeRAM address area 181 of the memory unit 180 is activated. Accordingly, the data write or read operation is performed on the FeRAM address area 181 (step S13).

On the other hand, when the command signal RX applied to the digital unit 170 does not correspond to the FeRAM access mode but the LED command register access mode, the LED command register address is applied to the memory unit 180 (step S14).

In this case, the register address area 182 of the memory unit 180 is activated. Accordingly, the data write or read operation is performed on the LED command register address area 182 (step S15).

For example, the digital unit 170 determines whether the command signal RX applied through the interface unit 160 is the write operation or the read operation. Also, the digital unit 170 determines whether the address applied through the interface unit 160 corresponds to the LED command register address area 182 of the memory unit 180. Subsequently, information such as an LED control pattern and data is stored in the register area in a corresponding address area of the LED command register address area 182.

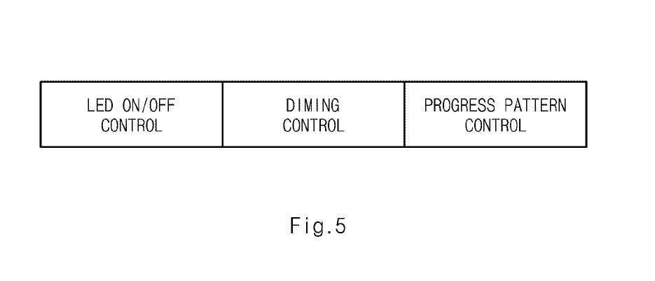

FIG. 5 is a diagram illustrating the structure of the data types in the plurality of registers REG1 to REGn.

Each of the registers REG1 to REGn includes a data storage area for controlling the on/off operation of the display device such as an LED. Also, each of the registers REG1 to REGn includes a dimming data storage area for adjusting brightness of the light in the display device such as the LED. Furthermore, each of the registers REG1 to REGn includes a data storage area for controlling a progress pattern in the display device such as the LED.

In this embodiment, the command signal for controlling the LED is stored in the memory unit 180. That is, an additional digital circuit is required in order to store the serial data applied through the interface unit 160 in the memory of the RFID chip 100. In this embodiment, the memory capacity is increased by additionally providing the LED command register address area 182 in the memory unit 180, and the LED driving command is stored in the LED command register address area 182.

In recent years, lighting installed in buildings are using a plurality of LEDs. In this case, a specific light pattern can be provided by individually controlling the on/off operations of the LEDs. Furthermore, a desired brightness can be provided by controlling individual LEDs among the plurality of LEDs, or LEDs positioned at desired locations can be separately controlled.

In the above-described lighting controlling method, the lightings can be remotely controlled through the RFID device. Specifically, an RFID tag is attached to an LED device, and a desired signal is transmitted over a radio frequency through an external reader. The RFID tag attached to the LED device recognizes the transmitted signal and receives a separate command according to a unique ID. In this way, the number and brightness of the LEDs can be controlled as desired.

Such an RFID tag is relatively cheaper than a general wireless remote controller. Hence, in a case where the RFID tag is applied to the lighting or the like, the implementation costs can be reduced and more options can be provided to users.

The embodiments of the present invention have the following effects.

First, the display devices such as LEDs can be remotely controlled by the RFID chip by coupling the display devices to the RFID chip.

Second, the LEDs can be controlled in various manners by providing the nonvolatile registers for storing the LED operation command data within the RFID chip.

Third, the efficiency of the LED operation can be improved by controlling the LEDs based on the radio signal or the wired signal through the RFID chip.

The above embodiments of the present invention are illustrative and not limitative. Various alternatives and equivalents are possible. Other additions, subtractions, or modifications are obvious in view of the present disclosure and are intended to fall within the scope of the appended claims.

What is claimed is:

1. A radio frequency identification (RFID) system comprising:
an input unit configured to generate a command signal according to a radio signal applied through an antenna;
a digital unit configured to generate an address, input/output data, and a control signal based on the command signal;
a memory unit configured to perform a data read or write operation according to the control signal and the address applied from the digital unit, the memory unit including a first address area to store first data for transmitting and receiving the radio signal, and a second address area to store second data for controlling an external driving device;
a coupling unit configured to couple the external driving device and the RFID system; and
a driving controller configured to output a driving signal for controlling the driving device according to second data stored in the memory unit, and output the driving signal to the coupling unit.

2. The RFID system according to claim 1, wherein the input unit comprises:
a demodulator configured to demodulate the radio signal and generate a first command signal;
an interface unit configured to control a serial interface signal applied from an external node and generate a second command signal; and
a command signal input unit configured to activate the command signal when the first command signal from the demodulator or the second command signal from the interface unit, or both are activated.

3. The RFID system according to claim 2, wherein the input unit further comprises:
a data input pad configured to receive a serial data and output the received serial data to the interface unit; and
a clock input pad configured to receive a serial clock and output the received serial clock to the interface unit.

4. The RFID system according to claim 1, wherein the first address area comprises a nonvolatile ferroelectric memory.

5. The RFID system according to claim 1, wherein the second address area comprises:
a plurality of registers configured to store the second data for controlling the driving device; and
a selection register configured to store data for selecting any one of the plurality of registers.

6. The RFID system according to claim 1, further comprising:
a plurality of decoders configured to decode output data of the second address area;
a selection decoder configured to output a selection signal; and
a selector configured to select any one of outputs of the plurality of decoders in response to the selection signal, wherein the selected output of the plurality of decoders is inputted to the driving controller.

7. The RFID system according to claim 1, wherein the second address area comprises at least one of data for controlling an on/off operation of the driving device, data for controlling brightness information of the driving device, and data for controlling a progress pattern of the driving device.

8. The RFID system according to claim 1, wherein the external device comprises a display device.

9. The RFID system according to claim 8, wherein the display device comprises light emitting diodes (LEDs).

10. The RFID system according to claim 9, wherein the second address area stores at least one of data for controlling an on/off operation of the LEDs, data for controlling brightness information of the LEDs, and data for controlling a progress pattern of the LEDs.

11. The RFID system according to claim 1, wherein the digital unit is configured to determine whether the command signal corresponds to the first address area or the second address area, and output the address corresponding to the first address area or the second address area to activate one of the first and second address areas.

12. The RFID system according to claim 1, wherein the RFID system is an RFID chip, the RFID chip further comprises:
a modulator configured to output a response signal corresponding to the command signal to the antenna;
a power on reset unit configured to generate and output a power on reset signal to the digital unit; and
a clock generator configured to generate and output a clock signal to the digital unit.

13. The RFID system according to claim 1, further comprising:
a power supply voltage pad configured to supply a power supply voltage to an RFID chip; and
a ground voltage pad configured to supply a ground voltage to the RFID chip.

14. The RFID system according to claim 1, wherein the coupling unit comprises pads coupled between the driving device and the driving controller.
